(19) United States
(12) Patent Application Publication
(10) Pub. No.: US 2012/0269194 A1
(43) Pub. Date: Oct. 25, 2012

(54) REPEATING DEVICE, COMMUNICATION SYSTEM, COMMUNICATION METHOD AND RECORDING MEDIUM FOR RECORDING PROGRAM

(75) Inventors: Noriaki KOBAYASHI, Tokyo (JP); Satoshi Kamiya, Tokyo (JP)

(73) Assignee: NEC Corporation, Tokyo (JP)

(21) Appl. No.: 13/449,185

(22) Filed: Apr. 17, 2012

(30) Foreign Application Priority Data
Apr. 20, 2011 (JP) 94254/2011

(51) Int. Cl. H04L 12/56

(52) U.S. Cl. 370/389

(57) ABSTRACT

A repeating device according to the present invention is connected with a communication device sending and receiving a packet via a network, for relaying the packet. The repeating device includes a destination determination unit for determining whether a destination of a received retransmission packet is within a communication system including the repeating device or outside the communication system and a retransmission control unit for performing retransmission control of the received retransmission packet, when a result of the determination shows a destination of the received retransmission packet is outside the communication system, and requesting retransmission control of the received retransmission packet to a transmission source of the received retransmission packet, when the result of the determination shows the destination of the received retransmission packet is within the communication system.

This application is based upon and claims the benefit of priority from Japanese Patent Application No. 2011-094254, filed on Apr. 20, 2011, the disclosure of which is incorporated herein in its entirety by reference.

### TECHNICAL FIELD

The present invention relates to a repeating device, a communication system and a communication method which perform packet communication, and a recording medium for recording a program.

### BACKGROUND ART

There is “packet retransmission control” as one technology for securing reliability of packet communication used in the Internet. In packet communication, discarding and destruction of a packet occurs during communication. The main causes of this include congestion of processing in a router and a switch which perform packet communication, a decline in the signal reception sensitivity in communication paths, external electromagnetic noises and the like. Packet loss by such discarding and destruction is detected by a protocol which operates in the application layer or the transport layer. A packet detected to be lost is retransmitted by such protocol, and reliability of communication is secured.

Specifically, in usual packet communication, first, a transmitter transmits a packet to a receiver. Next, when a packet is received, the receiver sends back an ACK (Acknowledgement) to the transmitter. By this ACK, the transmitter recognizes that the transmitted packet has reached to the receiver safely.

However, when a packet is discarded by a network between the transmitter and the receiver, the transmitter does not receive an ACK for the transmitted packet. Accordingly, when an ACK is not received within a predetermined waiting time after the packet transmission, the transmitter transmits the transmitted packet to the receiver once again. Meanwhile, this predetermined waiting time is called “Retransmission Time Out (RTO).”

As a typical protocol of the transport layer which performs such packet retransmission control, TCP (Transmission Control Protocol) is exemplified.

A technology related to such packet retransmission control is disclosed in non-patent document 1. According to non-patent document 1, the packet retransmission control is conducted in MAC (Media Access Control) layer (or the physical layer) that is a lower layer than the transport layer. The reason is as follows.

As an example, a network having a very short RTT (Round Trip Time) such as a network in a data center (DC: Data Center) is considered. In such a network, by reducing Retransmission Time Out to a micro second level, it is possible to decrease FCT (Flow Completion Time), and improve the communication efficiency.

However, because TCP is generally implemented on an OS (Operating System), it is difficult for packet retransmission control by TCP to reduce Retransmission Time Out to a micro second level.

For example, because a unit time in Linux (Jiffies) is several milliseconds at shortest, it is difficult to reduce Retransmission Time Out to a micro second level by an average TCP of Linux. In order to settle such problem, packet retransmission control is being conducted in the MAC layer in non-patent document 1, and Retransmission Time Out is reduced even to a micro second level.

In addition to these, as a technology of retransmission control, patent document 1 and patent document 2 can also be cited. According to patent document 1 and patent document 2, in order to suppress losses when relaying a packet and to improve communication efficiency of a network, retransmission control is carried out not only in the transmitter of the packet but also in a repeating device which relays the packet.

On the other hand, due to increase of data traffic and remarkable development of cloud services in recent years, there is an increasing need for long-distance communication between a plurality of networks and data centers which exist in distant places from each other.

A technology about data backup in a system that needs such long-distance communication is disclosed in non-patent document 2. In non-patent document 2, there is disclosed a system that achieves backup by making a mirror traffic flow between storages to cope with a system interruption caused by an unknown trouble such as a natural disaster and an artificial disaster.

In the technology of non-patent document 2, data is sent and received via a network, such as the internet, in which the communication standard is different from the network in a data center. In such communication, a communication apparatus for connecting networks having different communication standards from each other is needed. Hereinafter, such communication apparatus is called a gateway. Because data access concentrates on a gateway, its processing performance for packets is high compared with a communication apparatus used within a network, and its storage capacity for storing data temporarily is large.

In recent years, in data centers, a communication standard referred to as FC (Fiber Channel) is often used within a data center. In non-patent document 3, there is disclosed a technology referred to as FCoE (Fiber Channel Over Ethernet) which replaces communication below the MAC layer to Ethernet (registered trademark) that is frequently used by many networks using this FC.

According to non-patent document 3, it is said that, by standardizing layers below the MAC layer to Ethernet, reduction in management costs and improvement of performance can be expected compared with the conventional technology. However, because, in layers higher than the MAC layer, difference in communication methods still exists, when information is transmitted from a data center to an external network, it is similar to the past in a point that a gateway is required. In addition, retransmission control and congestion control is dependent on upper layers.

Also, in patent document 3, it is described that, when a possibility that data transmitted to a network has not been received is detected in a communication device, the data stored in a buffer is transmitted once again.

### RELATED ART DOCUMENTS

### Patent Documents

[Patent document 1] Japanese Patent Application Laid-Open No. 2010-141640
[Patent document 2] Japanese Patent Application Laid-Open No. 2003-304273
[Patent document 3] Japanese Patent Application Laid-Open No. 2007-267249

### Non-Patent Documents

[Non-patent document 1] Takamichi Toru et al., “Ultra High Speed MAC Technology for Terabit Class LAN”, 2008, Institute of Electronics, Information and Communication Engineers communication society meeting
[Non-patent document 2] NEC, BC/DR solution, [Mar. 3, 2011 searched] Internet <URL:http://www.nec.co.jp/solution/bcdr/index.html>
[Non-patent document 3] IEEE, Fiber Channel Backbone-5, [Mar. 31, 2011 searched] Internet <URL:http://www.fcoe.com/09-056v5.pdf>

### SUMMARY

An example of an object of the present invention is to avoid increase of the memory size needed for retransmission control in a communication device in long-distance communications.

A repeating device according to the present invention is connected with a communication device sending and receiving a packet via a network, for relaying the packet. The repeating device includes a destination determination unit for determining whether a destination of a received retransmission packet is within a communication system including the repeating device or outside the communication system and a retransmission control unit for performing retransmission control of the received retransmission packet, when a result of the determination shows a destination of the received retransmission packet is outside the communication system, and requesting retransmission control of the received retransmission packet to a transmission source of the received retransmission packet, when the result of the determination shows the destination of the received retransmission packet is within the communication system.

A communication system according to the present invention includes a communication device sending and receiving a packet via a network and a repeating device relaying the packet. The repeating device includes a destination determination unit for determining whether a destination of a received retransmission packet is within the communication system or outside the communication system and a retransmission control unit for performing retransmission control of the received retransmission packet, when a result of the determination shows a destination of the received retransmission packet is outside the communication system, and requesting retransmission control of the received retransmission packet to a transmission source of the received retransmission packet, when the result of the determination shows the destination of the received retransmission packet is within the communication system.

A communication method according to the present invention includes the steps of determining whether a destination of a received retransmission packet is within a communication system including a repeating device for relaying the packet, the repeating device being connected with a communication device sending and receiving a packet via a network, or outside the communication system and performing retransmission control of the received retransmission packet, when a result of the determination shows a destination of the received retransmission packet is outside the communication system, and requesting retransmission control of the received retransmission packet to a transmission source of the received retransmission packet, when the result of the determination shows the destination of the received retransmission packet is within the communication system.

A recording medium for recording a program according to the present invention causes a computer to carry out: destination determination processing for determining whether a destination of a received retransmission packet is within a communication system including a repeating device for relaying the packet, the repeating device being connected with a communication device sending and receiving a packet via a network, or outside the communication system; and retransmission control processing to perform retransmission control of the received retransmission packet, when a result of the determination shows a destination of the received retransmission packet is outside the communication system, and to request retransmission control of the received retransmission packet to a transmission source of the received retransmission packet, when the result of the determination shows the destination of the received retransmission packet is within the communication system.

### BRIEF DESCRIPTION OF THE DRAWINGS

Exemplary features and advantages of the present invention will become apparent from the following detailed description when taken with the accompanying drawings in which:

FIG. 1 is a diagram showing a structure of a first exemplary embodiment;

FIG. 2 is a flow chart showing an operation according to the first exemplary embodiment;

FIG. 3 is a diagram showing a structure of a system according to a second exemplary embodiment;

FIG. 4 is a diagram showing a structure of a communication device according to the second exemplary embodiment;

FIG. 5 is a diagram showing a structure of a retransmission control unit according to the second exemplary embodiment;

FIG. 6 is a diagram showing a structure of a retransmission applied packet according to the second exemplary embodiment;

FIG. 7 is a diagram showing a structure of a transmission unit according to the second exemplary embodiment;

FIG. 8 is a diagram showing a structure of a retransmission buffer according to the second exemplary embodiment;

FIG. 9 is a diagram showing a structure of a repeating device according to the second exemplary embodiment;

FIG. 10 is a flow chart showing an operation according to the second exemplary embodiment;

FIG. 11 is a flow chart showing an operation according to the second exemplary embodiment;

FIG. 12 is a flow chart showing an operation according to the second exemplary embodiment;

FIG. 13 is a flow chart showing an operation according to the second exemplary embodiment;

FIG. 14 is a flow chart showing an operation according to the second exemplary embodiment;

FIG. 15 is a diagram showing a structure of a system according to modification 1;

FIG. 16 is a diagram showing a structure of a system according to modification 2; and

FIG. 17 is a diagram showing structures of a communication device and a repeating device according to modification 3.

### EXEMPLARY EMBODIMENT

Hereinafter, the exemplary embodiments of the present invention will be described in detail with reference to drawings.

### The First Exemplary Embodiment

(Structure)

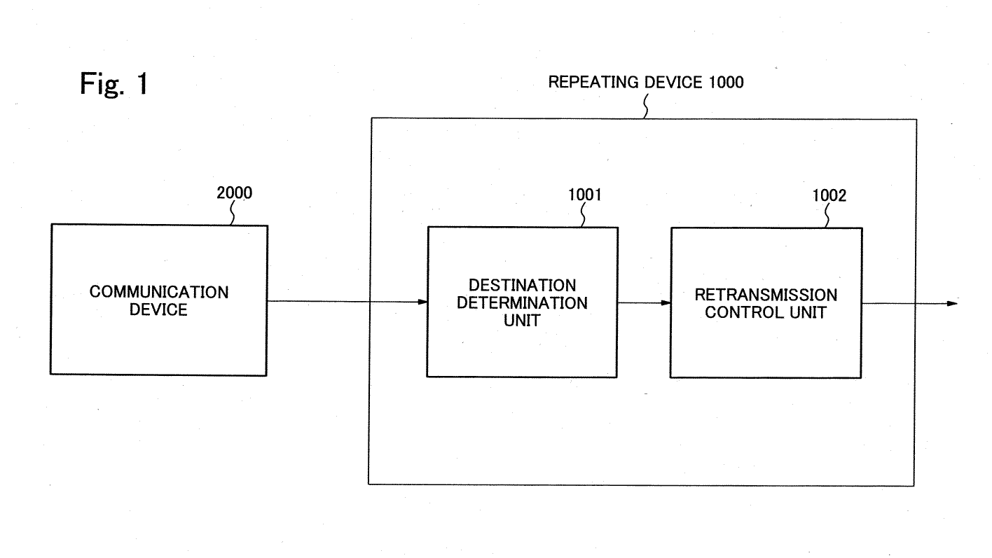

Firstly, the first exemplary embodiment of the present invention will be described. Referring to FIG. 1, the first exemplary embodiment of the present invention includes a repeating device 1000 and a communication device 2000.

The communication device 2000 is a device which sends and receives a packet via a network. The repeating device 1000 is a device which relays a packet communicated by the communication device 2000 or the like. The repeating device 1000 includes a destination determination unit 1001 and a retransmission control unit 1002.

(Operation)

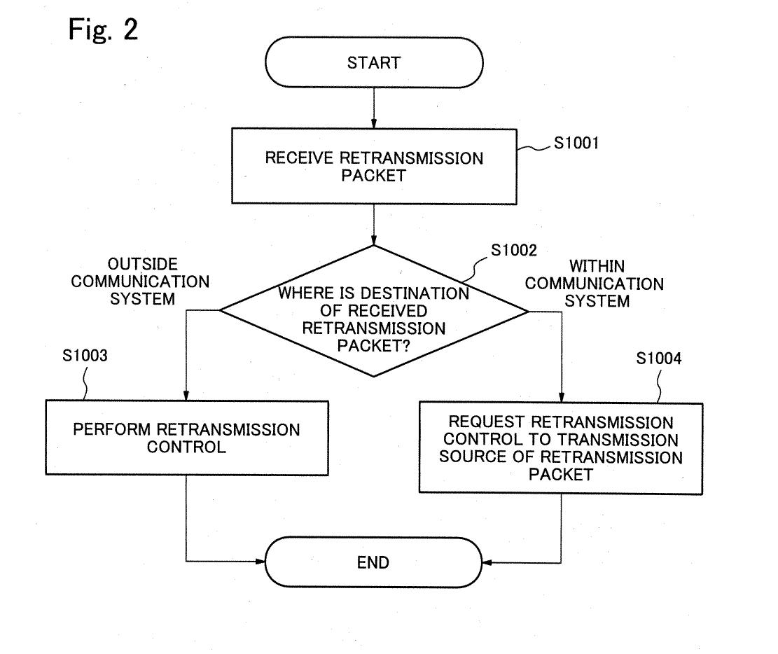

Next, an operation of the repeating device 1000 will be described using the flow chart of FIG. 2. First, the repeating device 1000 receives a retransmission packet (Step S1001).

Next, the destination determination unit 1001 determines whether the destination of the received retransmission packet exists inside or outside a communication system to which the repeating device 1000 belongs (Step S1002).

Next, according to the determination of Step S1002, the retransmission control unit 1002 performs the operations of Step S1003 and Step S1004. When, at Step S1002, the destination of the retransmission packet is determined to be outside the communication system to which the repeating device 1000 belongs, the retransmission control unit 1002 performs retransmission control and then processing is ended (Step S1003).

When, at Step S1002, the destination of the retransmission packet is determined to be inside the communication system to which the repeating device 1000 belongs, the retransmission control unit 1002 requests retransmission control of the retransmission packet to the transmission source of the retransmission packet and processing is ended (Step S1004).

(Advantage)

As mentioned above, according to the first exemplary embodiment, the retransmission control unit 1002 performs retransmission control personally or requests retransmission control to the transmission source of the retransmission packet depending on the destination of the retransmission packet received by the repeating device 1000.

According to the above operation, a communication device which is not a repeating device does not need to perform packet retransmission control in long-distance communication (communication whose destination is outside the system). Accordingly, it becomes possible to avoid increase of a memory size needed for retransmission control by a communication device which is not a repeating device.

### The Second Exemplary Embodiment

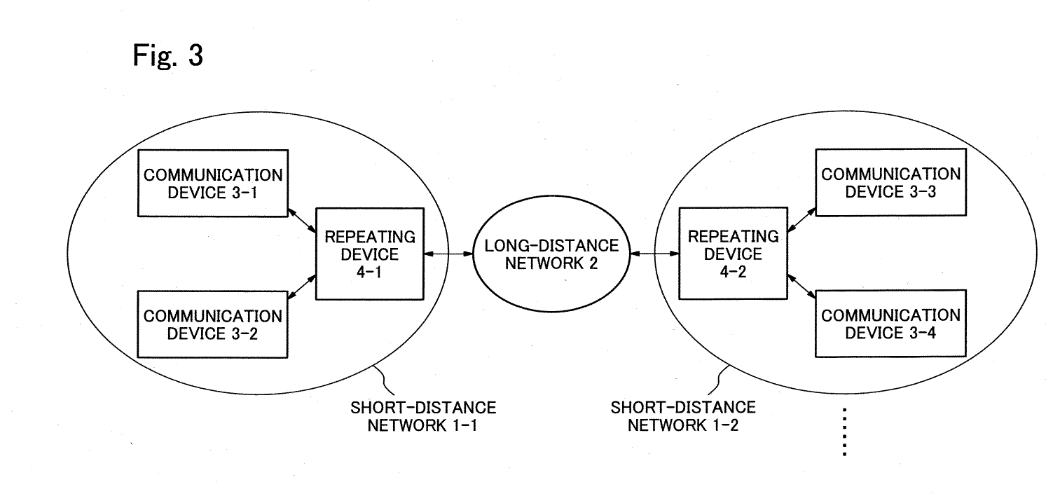

Next, the second exemplary embodiment of the present invention will be described. FIG. 3 is a diagram indicating a structure of a communication system according to the second exemplary embodiment.

(Structure)

According to FIG. 3, a communication system according to the second exemplary embodiment includes a short-distance network 1-1, a short-distance network 1-2 and a long-distance network 2. Hereinafter, when the short-distance networks 1-1 and 1-2 are not distinguished in particular, each of them is called a short-distance network 1.

Each short-distance network 1 is an independent network. The long-distance network 2 transmits a packet sent and received between one short-distance network 1 and the other short-distance network 1. Henceforth, this transmitted packet is called a packet 10. A packet to be transmitted is a general packet, and is a group of data in which information required for control such as MAC addresses of a transmission source and a destination are added.

A short-distance network 1 includes a communication device 3 which sends and receives the packet 10, and a repeating device 4 arranged in a boundary of the short-distance network 1 and the long-distance network 2.

Here, in FIG. 3, more than one communication device 3 and repeating device 4 exist. Specifically, the short-distance network 1-1 includes a communication device 3-1, a communication device 3-2 and a repeating device 4-1. Similarly, the short-distance network 1-2 includes a communication device 3-3, a communication device 3-4 and a repeating device 4-2. Hereinafter, when not needed to distinguish about each communication device in particular, it is called a communication device 3. Similarly, when not needed to distinguish about each repeating device in particular, it is called a repeating device 4. Meanwhile, the function of each communication device 3 is similar to each other, and the function of each repeating device 4 is similar to each other.

In FIG. 3, although two pieces of short-distance network 1 are included, they are not limited to two and may be no smaller than three.

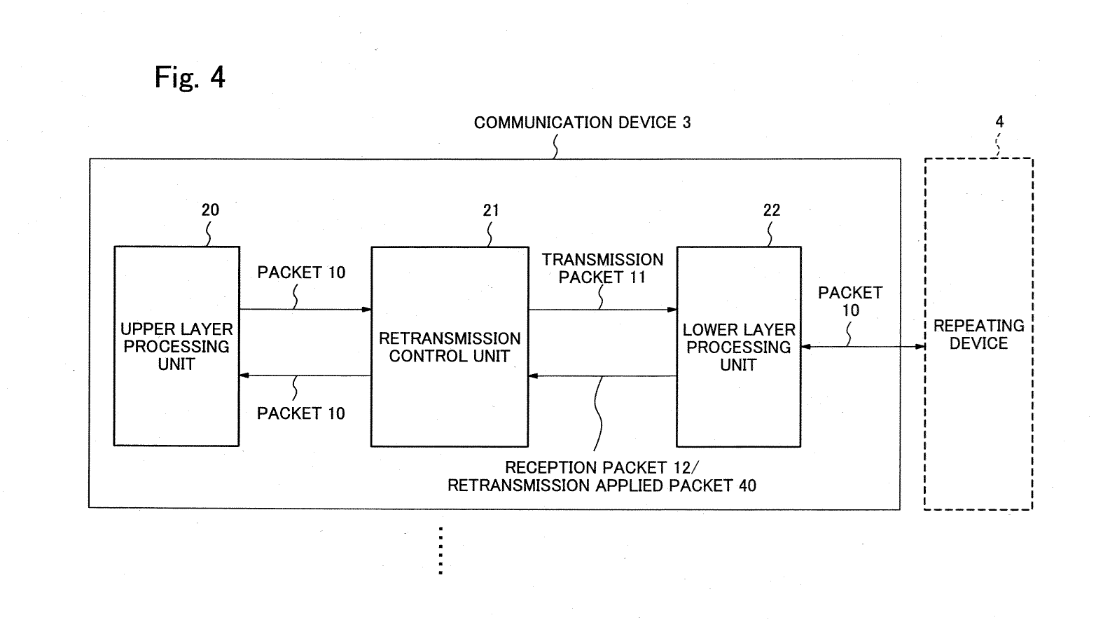

Next, a configuration of the communication device 3 will be described. FIG. 4 is a diagram which indicates a structure of a communication device 3. According to FIG. 4, the communication device 3 includes an upper layer processing unit 20, a retransmission control unit 21 and a lower layer processing unit 22.

The upper layer processing unit 20 performs processing of the transport layer or the application layer. A protocol of the transport layer includes the above-mentioned TCP, UDP (User Datagram Protocol) and the like. A protocol of the application layer includes HTTP (Hyper Text Transport Protocol), SMTP (Simple Mail Transfer Protocol) and the like.

The retransmission control unit 21 performs retransmission control processing to the packet 10 inputted from the upper layer processing unit 20, and outputs it to the lower layer processing unit 22. Also, the retransmission control unit 21 receives a reception packet 12 or a retransmission applied packet 40 from the lower layer processing unit 22. When the reception packet 12 inputted from the lower layer processing unit 22 is an ACK, the retransmission control unit 21 terminates that. The reception packet 12 may include the packet 10 itself. When the reception packet 12 includes the packet 10, the reception packet 12 is transmitted to the upper layer processing unit 20, and, in addition, an ACK is generated to be sent back to the sending side. The retransmission control unit 21 and the retransmission applied packet 40 will be described in detail later.

The lower layer processing unit 22 performs processing of the MAC layer and the link layer. As a protocol of the MAC layer and the link layer, Ethernet can be exemplified. The lower layer processing unit 22 transmits a transmission packet 11 inputted from the retransmission control unit 21 to the repeating device 4 following a predetermined procedure. At the same time, the lower layer processing unit 22 outputs the reception packet 12 or the retransmission applied packet 40 received from the repeating device 4 to the retransmission control unit 21.

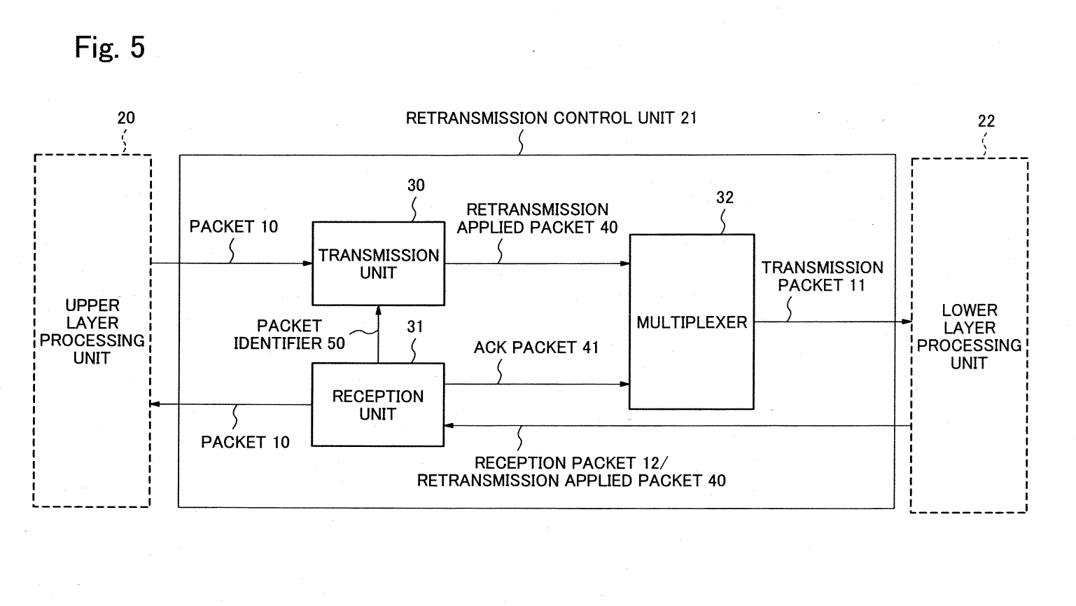

Next, the retransmission control unit 21 will be described in detail. FIG. 5 is a diagram showing a structure of the retransmission control unit 21. The retransmission control unit 21 includes a transmission unit 30, a reception unit 31 and a multiplexer 32.

The transmission unit 30 generates the retransmission applied packet 40 based on the packet 10 received from the upper layer processing unit 20. Next, the retransmission applied packet 40 generated is outputted to the multiplexer 32. On this occasion, the transmission unit 30 stores the data of the retransmission applied packet 40. When an ACK packet 41 corresponding to the transmitted retransmission applied packet 40 has not been received from the reception unit 31 before Retransmission Time Out passes, the transmission unit 30 resends the retransmission applied packet 40.

The retransmission applied packet 40 and the ACK packet 41 are packets to be generated or terminated by the retransmission control unit 21. As a retransmission applied packet 40, a form in which information required for retransmission control is given to the packet 10 can be adopted, for example. The ACK packet 41 represents an acknowledgement. Because, as an ACK packet 41, a general ACK, an ACK packet and something called an ACK may be simply used, the detailed description will be omitted.

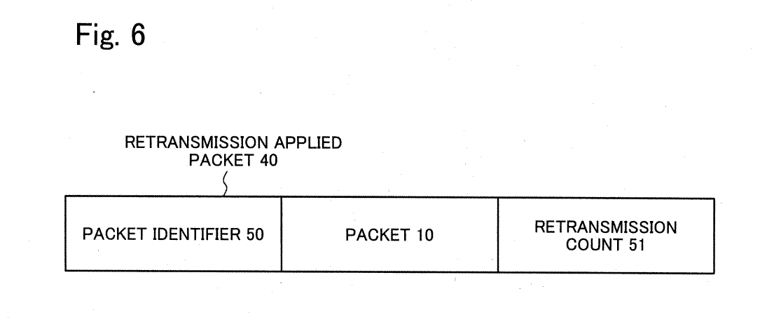

FIG. 6 indicates an exemplary configuration of the retransmission applied packet 40. According to FIG. 6, the retransmission applied packet 40 is a packet with a packet identifier 50 and a retransmission count 51 added to the packet 10.

The packet identifier 50 is information required in order to identify the packet 10. The content of the packet identifier 50 may be a part of or all of inside information and user data of the packet 10, or may be an element generated originally irrespective of the inside information. As an example, the sequence number of the packet 10, information on the packet header of the packet 10 or the like is mentioned.

The retransmission count 51 is a numerical value which indicates the number of times that the retransmission applied packet 40 has been retransmitted. The retransmission count 51 has a predetermined upper limit value L (L is a natural number). The initial value of the retransmission count 51 is 0 typically, and a retransmission applied packet in which the retransmission count 51 is 0 is not regarded as a retransmission packet. The upper limit value and the initial value of the retransmission count 51 can be changed appropriately.

Returning to FIG. 5 once again, description of the retransmission control unit 21 will be continued. The reception unit 31 receives the reception packet 12 or the retransmission applied packet 40 from the lower layer processing unit 22. The reception unit 31 determines whether the received packet is the reception packet 12 or the retransmission applied packet 40. When the received packet is determined to be the retransmission applied packet 40, the reception unit 31 extracts the packet identifier 50 from the received retransmission applied packet 40. Next, the reception unit 31 generates the ACK packet 41 based on the extracted packet identifier 50. The reception unit 31 outputs the generated ACK packet 41 to the multiplexer 32. At the same time, the reception unit 31 removes information on retransmission control from the retransmission applied packet 40, and outputs it to the upper layer processing unit 20 as the packet 10.

Also, the reception unit 31 extracts the packet identifier 50 from the ACK packet 41 received from the lower layer processing unit 22, and outputs the extracted packet identifier 50 to the transmission unit 30. Here, when the ACK packet 41 is transmitted from the repeating device 4 and its content instructs the communication device 3 to carry out retransmission control, the packet identifier 50 is not extracted and nothing is outputted to the transmission unit 30. In any of the cases, the ACK packet 41 is terminated in the reception unit 31.

Here, when the retransmission applied packet 40 includes overlapped information, it is desirable to reduce the length of the retransmission applied packet 40 by not adding the information. It is because unnecessary check processing to the retransmission applied packet 40 by each device can be reduced by reducing the length of the retransmission applied packet 40, and, as a result, further improvement of the communication efficiency is expected.

Specifically, a case where the number of retransmissions of the retransmission applied packet 40 is being managed in the retransmission control unit 21 is mentioned. In such case, because the retransmission applied packet 40 of FIG. 6 includes the retransmission count 51, the retransmission count 51 becomes redundant. Accordingly, the retransmission count 51 of the retransmission applied packet 40 may be omitted. By omission of such information, even if retransmission processing is performed without using the retransmission applied packet 40, it is permissible in this exemplary embodiment.

The multiplexer 32 multiplexes the retransmission applied packet 40 received from the transmission unit 30 and the ACK packet 41 received from the reception unit 31, and transmits it to lower layer processing part 22 as the transmission packet 11.

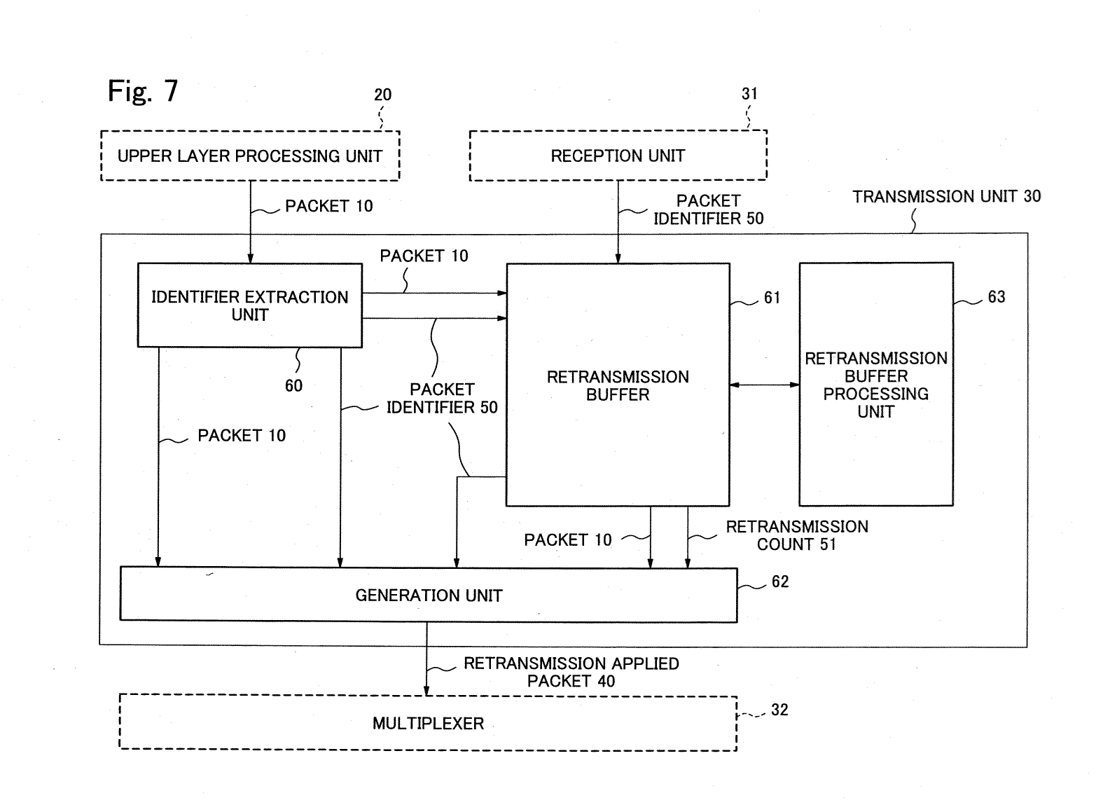

Next, the transmission unit 30 will be described in detail using a drawing. FIG. 7 is a diagram showing a structure of the transmission unit 30. The transmission unit 30 includes an identifier extraction unit 60, a retransmission buffer 61, a generation unit 62 and a retransmission buffer processing unit 63.

The identifier extraction unit 60 extracts the packet identifier 50 from the packet 10 received from the upper layer processing unit 20, and outputs the extracted packet identifier 50 to the retransmission buffer 61.

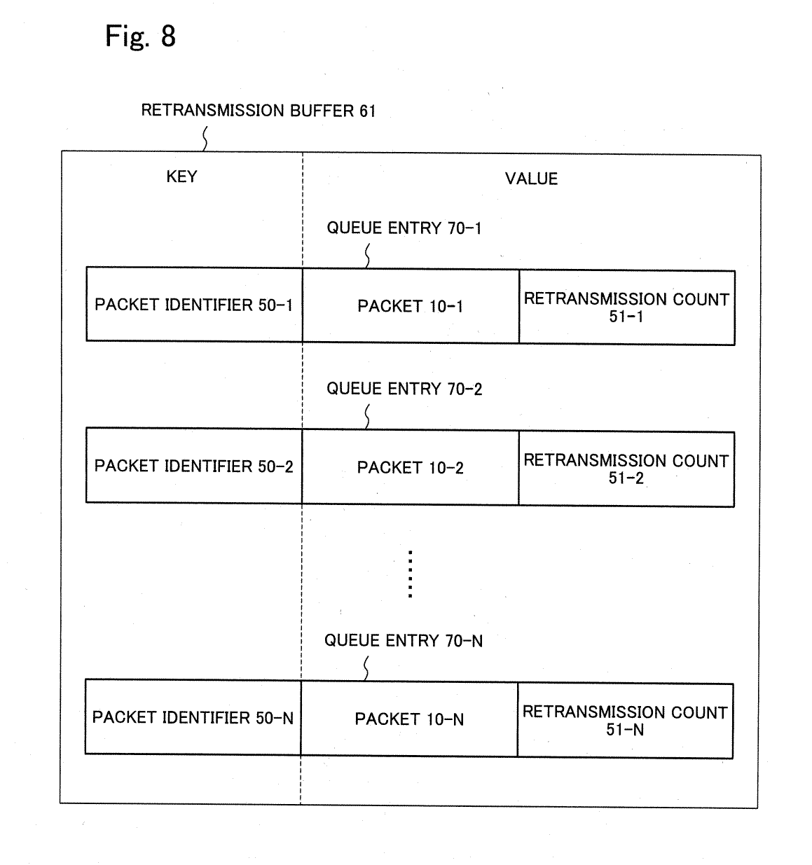

Here, the retransmission buffer 61 will be described in detail using a drawing. FIG. 8 is a diagram showing an exemplary configuration of the retransmission buffer 61.

The retransmission buffer 61 is a queue of a FIFO (First In and First Out) type that stores no smaller than zero of a queue entry 70. In the example of FIG. 8, there is indicated an exemplary configuration in which a total of N pieces of queue entry 70 are included: a queue entry 70-1, a queue entry 70-2 to a queue entry 70-N. Meanwhile, henceforth, when not needed to distinguish in particular, each queue entry is called a queue entry 70.

In FIG. 8, the first queue entry 70-1 is the oldest, and the final queue entry 70-N is the newest. A queue entry 70 houses the content of the retransmission applied packet 40 received by the retransmission buffer 61: that is, the packet 10, the packet identifier 50 and the retransmission count 51.

Returning to FIG. 7, based on information received from the identifier extraction unit 60 and the retransmission buffer 61, the generation unit 62 generates the retransmission applied packet 40, and outputs it to the multiplexer 32.

Next, in order to manage Retransmission Time Out of the queue entry 70, the retransmission buffer processing unit 63 has, for each queue entry 70, a function to measure an elapsed time after being added to the retransmission buffer 61.

Also, in the retransmission buffer 61, the retransmission buffer processing unit 63 performs retransmission processing indicated below to the queue entry 70 for which Retransmission Time Out has been expired.

After the packet 10, the packet identifier 50 and the retransmission count 51 in the queue entry 70 are outputted from the retransmission buffer 61 to the generation unit 62, the retransmission buffer processing unit 63 determines whether the retransmission count 51 reaches the predetermined upper limit value L or not. Here, when the retransmission count 51 reaches the upper limit value L, the retransmission buffer processing unit 63 erases the corresponding queue entry 70 from the retransmission buffer 61.

When the retransmission count 51 in the queue entry 70 does not reach the upper limit value L in the retransmission buffer 61, the retransmission buffer processing unit 63 increases the retransmission count 51 by 1. The elapsed time of the queue entry 70 is reset. Next, the queue entry 70 is moved to the end of the retransmission buffer 61, and again, waits for expiration of Retransmission Time Out.

When the queue entry 70 with the same packet identifier 50 as the packet identifier 50 received from the reception unit 31 exists in the retransmission buffer 61, the retransmission buffer processing unit 63 eliminates the queue entry 70 from the retransmission buffer 61.

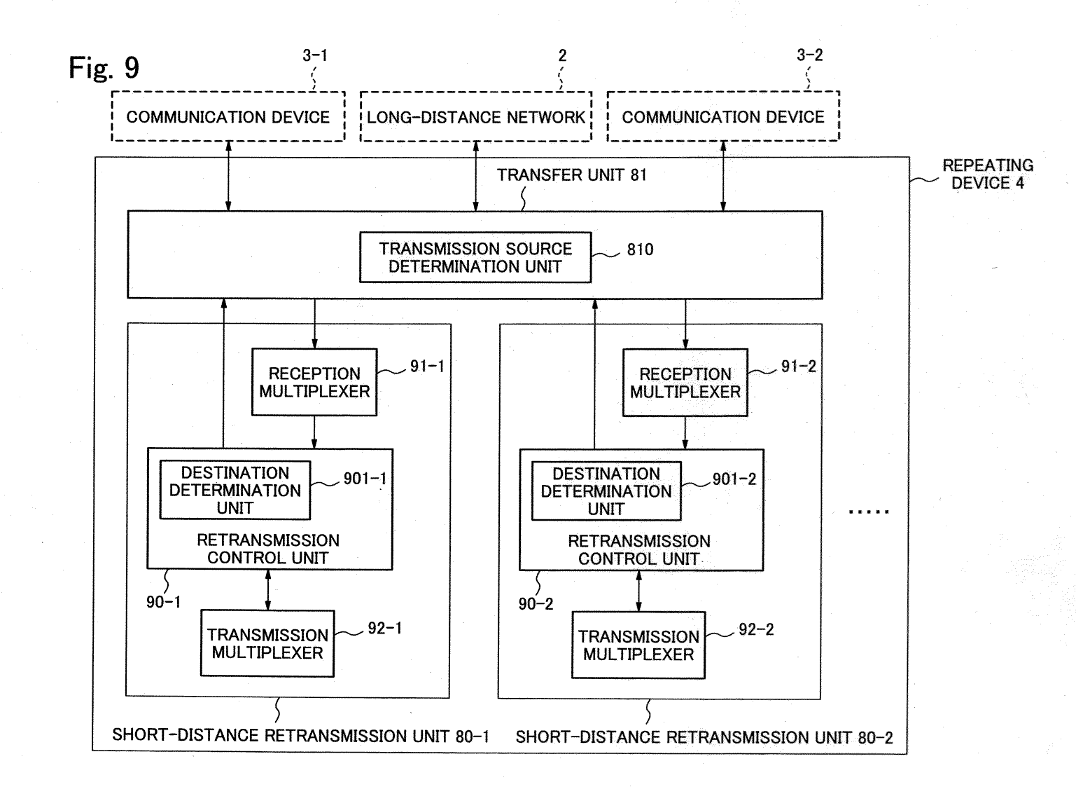

Next, the repeating device 4 will be described. FIG. 9 is a diagram showing a structure of the repeating device 4. According to FIG. 9, the repeating device 4 is connected to the long-distance network 2 and the communication device 3. In the example of FIG. 9, it is supposed that the repeating device 4 is connected to a communication device 3-1 and a communication device 3-2. The repeating device 4 includes a short-distance retransmission unit 80 and a transfer unit 81. Hereinafter, each unit will be described in detail.

First, the short-distance retransmission unit 80 includes a retransmission control unit 90, a reception multiplexer 91 and a transmission multiplexer 92. In the example of FIG. 9, there exist two short-distance retransmission units: a short-distance retransmission unit 80-1 connected to the communication device 3-1 and a short-distance retransmission unit 80-2 connected to the communication device 3-2. The short-distance retransmission unit 80-1 includes a retransmission control unit 90-1, a reception multiplexer 91-1 and a transmission multiplexer 92-1. The retransmission control unit 90-1 includes a destination determination unit 901-1. Similarly, the short-distance retransmission unit 80-2 includes a retransmission control unit 90-2, a reception multiplexer 91-2 and a transmission multiplexer 92-2. The retransmission control unit 90-2 includes a destination determination unit 901-2. Henceforth, when not needed to distinguish in particular, they are called a short-distance retransmission unit 80, a retransmission control unit 90, a reception multiplexer 91, a transmission multiplexer 92 and a destination determination unit 901, respectively.

When a received packet is the retransmission applied packet 40, the retransmission control unit 90 performs retransmission control. In the destination determination unit 901, it is determined whether the destination of a received packet exists inside the short-distance network 1-1 to which the repeating device 4 belongs to or outside the short-distance network 1-1. Because the retransmission control unit 90 used here is of a structure similar to the retransmission control unit 21 in the communication device 3 mostly except for the destination determination unit 901, the detailed description will be omitted. Meanwhile, the short-distance retransmission unit 80 should simply be provided as many as the number of pieces of the communication device 3 connected to the repeating device 4.

The reception multiplexer 91 multiplexes packets received from the retransmission control unit 90 and transmits the multiplexed packets to the transfer unit 81. The transmission multiplexer 92 multiplexes packets received from the retransmission control unit 90 and transmits the multiplexed packets to the communication device 3.

The transfer unit 81 determines the destinations of packets received from the short-distance retransmission unit 80 and the long-distance network 2 to perform switching. That is, the transfer unit 81 transmits a packet to an appropriate short-distance retransmission unit 80, a communication device 3 or the long-distance network 2.

The transfer unit 81 includes a transmission source determination unit 810. The transmission source determination unit 810 determines whether the sender of a received packet exists inside the short-distance network 1-1 to which the repeating device 4 belongs or outside the short-distance network 1-1.

Meanwhile, description of detailed operations of the repeating device 4 will be made later.

(The Outline of Operations)

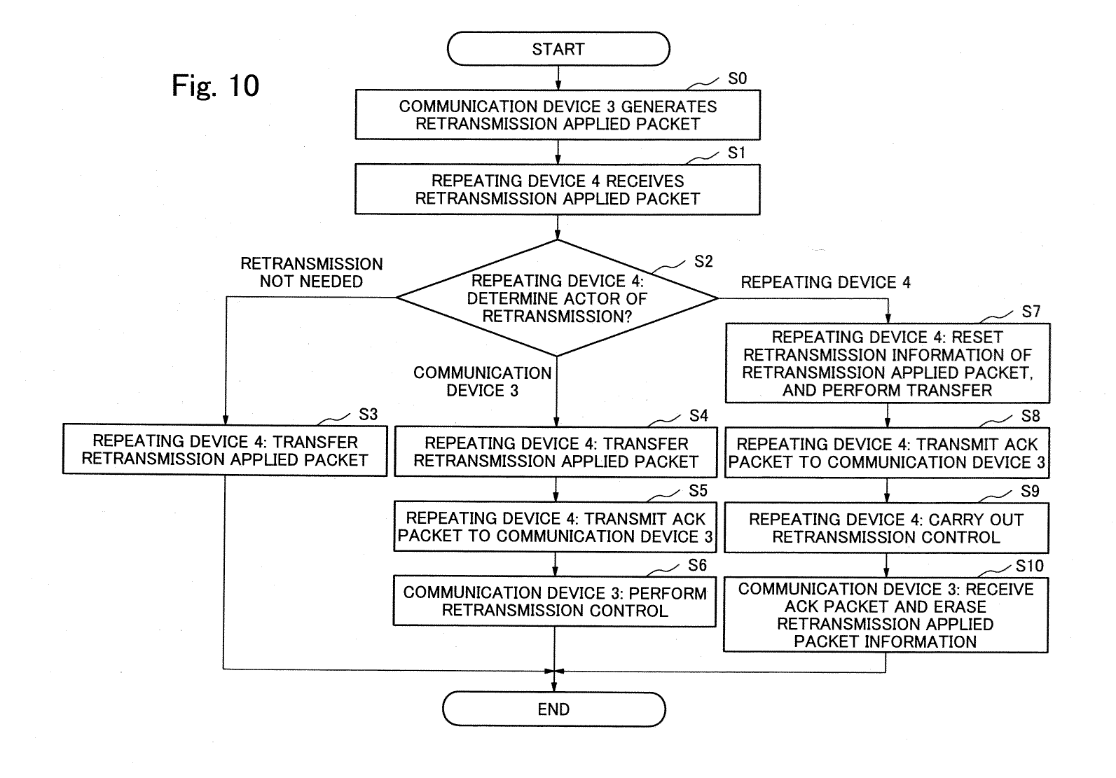

Next, the outline of the overall operation of this exemplary embodiment will be described. FIG. 10 is a flow chart showing operations until assignment of retransmission control of the retransmission applied packet 40 outputted from the communication device 3 is determined. Details of operations in each step or operations in each device will be described in detail later.

First, when retransmission of a packet becomes necessary, the communication device 3 generates the retransmission applied packet 40 and outputs it to the short-distance network 1 (Step S0).

Next, the repeating device 4 receives the retransmission applied packet 40 from the communication device 3 (Step S1).

Then, the repeating device 4 determines a device which is to perform retransmission control for the received retransmission applied packet 40 (Step S2). As a result of the determination of Step S2, when the retransmission applied packet 40 is not a subject of retransmission control, processing moves to Step S3. When retransmission control is performed by the communication device 3 that is a transmission source of the retransmission applied packet 40, processing moves to Step S4. When retransmission control is performed by the repeating device 4, processing moves to Step S7.

When it is determined at Step S2 that the retransmission applied packet 40 is not a subject of retransmission control, the repeating device 4 performs transfer of the retransmission applied packet 40 and finishes operating (Step S3).

When it is determined at Step S2 that the actor for retransmitting the retransmission applied packet 40 is the communication device 3 that is the transmission source of the retransmission applied packet 40, the repeating device 4 transfers the retransmission applied packet 40 to the communication device 3 (Step S4).

Next, the repeating device 4 transmits the ACK packet 41 requesting the communication device 3 that is the transmission source of the retransmission applied packet 40 to perform retransmission control (Step S5). Meanwhile, the kind of a packet for requesting the communication device 3 to perform retransmission control is not limited to an ACK packet, and it may be any kind of a packet which can just request retransmission control.

The communication device 3 receives the ACK packet 41 and performs retransmission control of the received retransmission applied packet 40 (Step S6).

When it is determined at Step S2 that the actor for retransmitting the retransmission applied packet 40 is the repeating device 4 itself, the repeating device 4 resets retransmission information of the retransmission applied packet 40. The repeating device 4 performs transfer of the retransmission applied packet 40 to which retransmission control is applied once more (Step S7).

Next, in order to inform the communication device 3 that is the transmission source of the retransmission applied packet 40 that the repeating device 4 itself performs retransmission control, the repeating device 4 transmits the ACK packet 41 (Step S8). Meanwhile, the kind of a packet for notifying the communication device 3 that the repeating device 4 personally performs retransmission is not limited to an ACK packet, and it may be of any kind.

After that, the repeating device 4 carries out retransmission control of the retransmission applied packet 40 (Step S9).

Finally, the communication device 3 receives the ACK packet 41 and erases retransmission information of the retransmission applied packet 40 (Step S10).

Meanwhile, Step S9 may be performed before Step S8 or after Step S10. Step S9 also can be carried out in parallel with Step S8 or Step S10.

(Operations of the Communication Device 3)

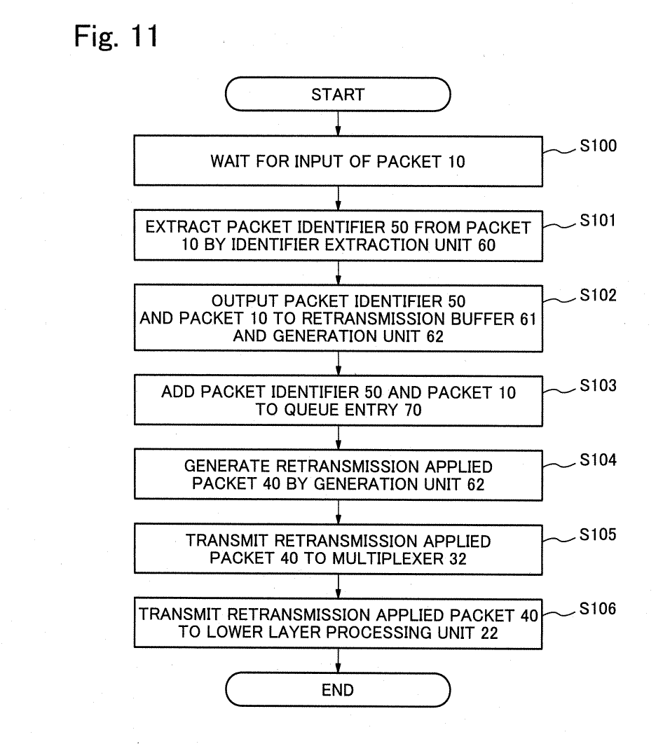

Hereinafter, about details of operations according to this exemplary embodiment, description will be made with reference to FIGS. 11 to 14.

First, operations of the communication device 3 in this exemplary embodiment will be described. Hereinafter, operations of transmission, retransmission and reception will be described in turn.

(Operations of the Communication Device 3: Transmission)

First, operations when the communication device 3 transmits a packet will be described. FIG. 11 shows an operation flow when the retransmission control unit 21 transmits the packet 10 inputted from the upper layer processing unit 20 to the lower layer processing unit 22. This operation flow shows details of the operation S0 of FIG. 10.

The retransmission control unit 21 waits for an input of the packet 10 from the upper layer processing unit 20 (Step S100).

Next, the identifier extraction unit 60 of the retransmission control unit 21 extracts the packet identifier 50 from the received packet 10 (Step S101).

Next, the retransmission control unit 21 outputs the packet identifier 50 which the identifier extraction unit 60 has extracted and the packet 10 to the retransmission buffer 61 and the generation unit 62 (Step S102).

After that, the retransmission buffer processing unit 63 registers the packet identifier 50 and the packet 10 received from the identifier extraction unit 60 with the queue entry 70. The registered queue entry 70 is placed at the end of the retransmission buffer (Step S103).

Based on the packet identifier 50 and the packet 10 which the generation unit 62 has received, the retransmission applied packet 40 is generated (Step S104).

Next, the generation unit 62 outputs the generated retransmission applied packet 40 to the multiplexer 32 (Step S105).

Finally, the multiplexer 32 outputs the retransmission applied packet 40 to the lower layer processing unit 22 and finishes operation (Step S106).

(Operations of the Communication Device 3: Retransmission)

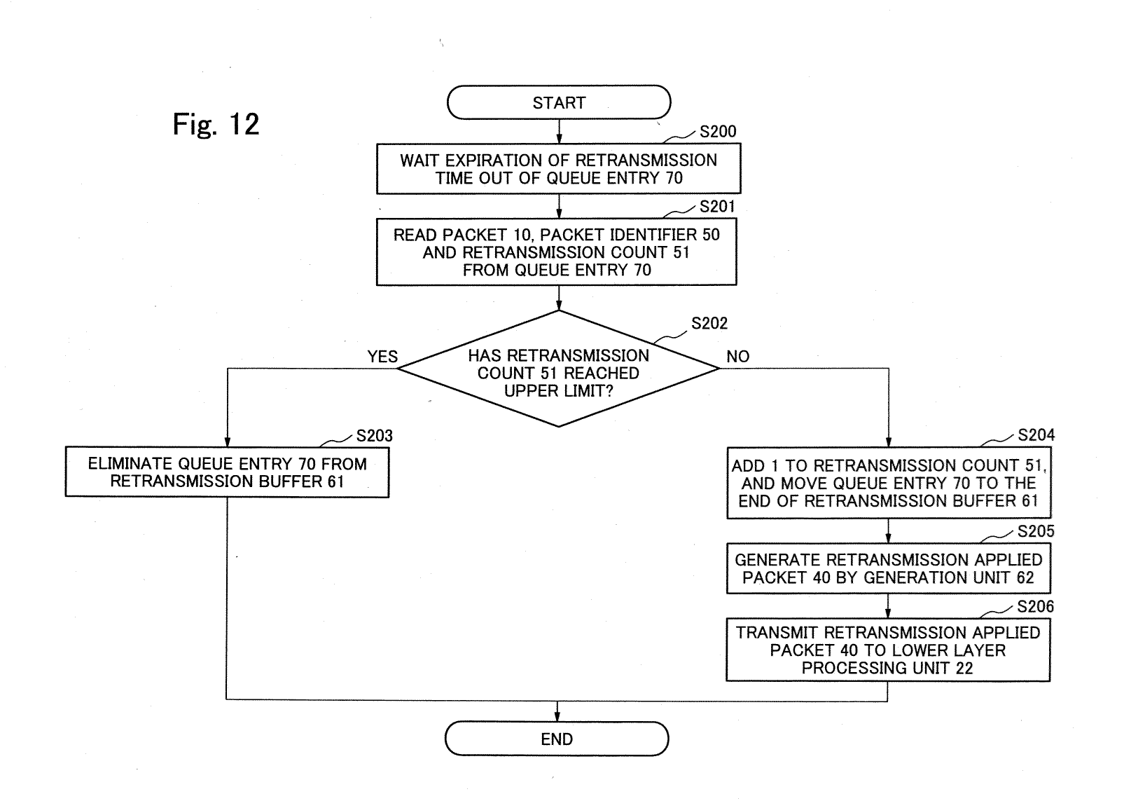

Next, operations of retransmission of the communication device 3 will be described. FIG. 12 is a flow chart showing operations when the retransmission control unit 21 retransmitting the packet 10 included in the queue entry 70 to the lower layer processing unit 22.

The retransmission buffer processing unit 63 of the retransmission control unit 21 wait until Retransmission Time Out for an elapsed time of the queue entry 70 registered with the retransmission buffer 61 in the transmission unit 30 expires (Step S200).

Next, the retransmission buffer processing unit 63 reads the packet 10, the packet identifier 50 and the retransmission count 51 from the queue entry 70 for which Retransmission Time Out has expired at S200 (Step S201).

Next, the retransmission buffer processing unit 63 determines whether the retransmission count 51 read at S201 in the transmission unit 30 reaches a predetermined upper limit (Step S202).

When it is judged that the number of retransmissions reaches the upper limit at Step S202, the retransmission buffer processing unit 63 eliminates the queue entry 70 from the retransmission buffer 61 (Step S203).

When the number of retransmissions does not reach the upper limit at Step S202, the retransmission buffer processing unit 63 increases the retransmission count 51 of the queue entry 70 by 1. The retransmission buffer processing unit 63 moves the queue entry 70 to the end of the retransmission buffer 61, and again, makes the queue entry 70 be a subject of retransmission processing. Then, the retransmission buffer processing unit 63 outputs the packet 10, the packet identifier 50 and the retransmission count 51 to the generation unit 62 (Step S204).

Based on the packet 10, the packet identifier 50 and the retransmission count 51 read at Step S201, the generation unit 62 generates the retransmission applied packet 40, and outputs it to the multiplexer 32 (Step S205).

The multiplexer 32 outputs the retransmission applied packet 40 to the lower layer processing unit 22, and finishes operation (Step S206).

(Operations of the Communication Device 3: Reception)

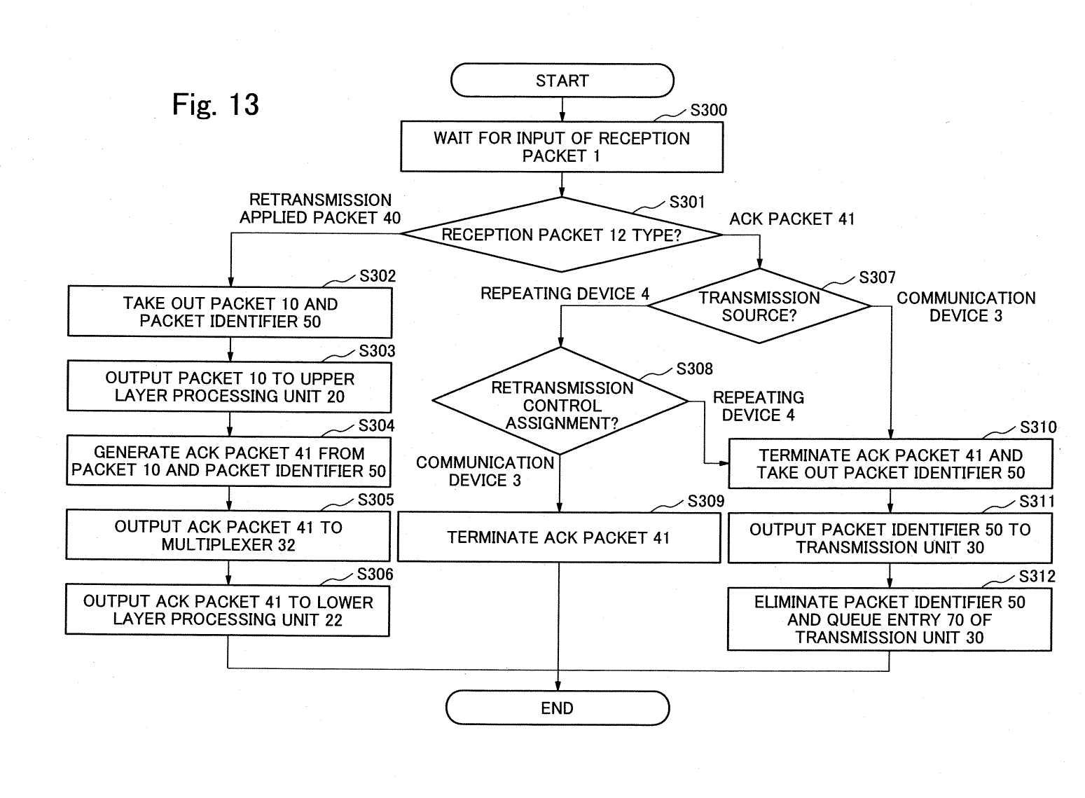

Hereinafter, operations of reception of the communication device 3 will be described. FIG. 13 is a flow chart showing operations until the retransmission control unit 21 performs each kind of output according to types of the reception packet 12. The following operation flow corresponds to details of operations S6 and S9 of FIG. 10.

First, the retransmission control unit 21 waits for input of the reception packet 12 from the lower layer processing unit 22 (Step S300).

Next, the reception unit 31 determines the type of the reception packet 12. Processing moves to S302 when the reception packet 12 is the retransmission applied packet 40, and when it is the ACK packet 41 to S307 (Step S301).

When the reception packet 12 is determined to be the retransmission applied packet 40 at Step S301, the reception unit 31 takes out the packet 10 and the packet identifier 50 from the retransmission applied packet 40 determined at S301 (Step S302).

Next, the reception unit 31 outputs the packet 10 taken out at S302 to the upper layer processing unit 20 (Step S303).

Next, based on the packet identifier 50 of the packet 10 taken out at S302, the reception unit 31 generates the ACK packet 41 (Step S304).

The reception unit 31 outputs the generated ACK packet 41 to the multiplexer 32 (Step S305). Meanwhile, the operations of S303 and from S304 to S305 may be performed in reverse order or in parallel.

Finally, the multiplexer 32 transmits the ACK packet 41 received from the reception unit 31 to the lower layer processing unit 22, and finishes operation (Step S306).

When it is determined that the reception packet 12 is the ACK packet 41 in Step S301, the reception unit 31 determines whether the transmission source of the ACK packet 41 determined in S301 is the repeating device 4 or the communication device 3 (Step S307). As a result of the determination, when the transmission source is the repeating device 4, processing moves to S308, and, when a transmission source is the communication device 3, processing moves to S310.

As a result of Step S307, when the transmission source of the ACK packet 41 is the repeating device 4, the reception unit 31 performs a flag check of the ACK packet 41, and determines whether an assignment of retransmission control of the target packet 10 is to itself (the communication device 3) or whether it is to the repeating device 4 (Step S308). When the assignment is to itself (the communication device 3), processing moves to S309, and, when it is to the repeating device 4, processing moves to S310.

At Step S308, when a retransmission control object flag indicates the retransmission control unit 21, the reception unit 31 terminates the ACK packet 41 and finishes operation (Step S309).

When the transmission source of the ACK packet 41 is besides the repeating device 4 at Step S307, or when the retransmission control object flag indicates the repeating device 4 at Step S308, the operation of Step S310 is performed. The reception unit 31 takes out the packet identifier 50 from the ACK packet 41, and the ACK packet 41 is terminated (Step S310).

The reception unit 31 outputs the packet identifier 50 taken out at S305 to the transmission unit 30 (Step S311).

Finally, the transmission unit 30 eliminates the queue entry 70 corresponding to the packet identifier 50 received from the reception unit 31, and finishes operation (Step S312).

(Operations of the Repeating Device 4)

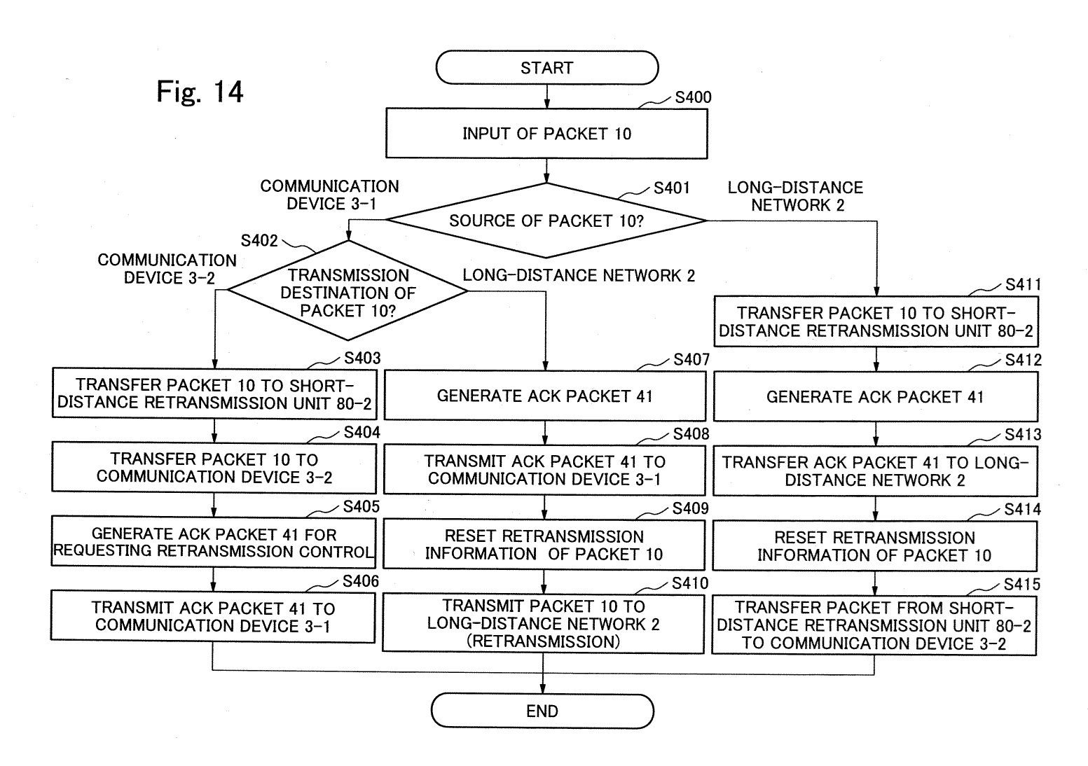

Hereinafter, operations of the repeating device 4 in this exemplary embodiment will be described in detail with reference to FIG. 14. The operation flow described below corresponds to the operations S1 to S5 and S7 to S8 of FIG. 10.

FIG. 14 indicates operations when the repeating device 4 performs reception of the packet 10 received from the communication device 3-1 or the long-distance network 2. At the same time, it also indicates operations when the repeating device 4 outputs the packet 10 to the communication device 3-2 or the long-distance network 2. Because the operations of the short-distance retransmission unit 80-1 and the short-distance retransmission unit 80-2 are basically similar to each other, the description will be omitted about the operation for inputting the packet 10 from the communication device 3-2 and outputting it to the communication device 3-1.

First, the repeating device 4 waits for input of the packet 10 (Step S400).

Next, the transmission source determination unit 810 of the repeating device 4 determines where the transmission source of the packet 10 is (Step S401). When the transmission source of the packet 10 is the communication device 3-1, processing moves to S402. When the transmission source of the packet 10 is the long-distance network 2, processing moves to S411.

As a result of the determination at S401, when it is determined that the transmission source of the packet 10 is the communication device 3-1, the repeating device 4 receives the inputted packet 10 using the retransmission control unit 90-1 of the short-distance retransmission unit 80-1 connected with the communication device 3-1. Destination determination unit 901-1 of the retransmission control unit 90-1 determines whether the transmission destination of the packet 10 is the communication device 3-2 or the long-distance network 2 (Step S402). When the transmission destination of the packet 10 is the communication device 3-2, processing moves to S403, and when it is the long-distance network 2, processing moves to S407.

When it is determined that the transmission destination of the packet 10 is the communication device 3-2 in Step S402, the repeating device 4 performs Step S403. The repeating device 4 transfers the packet 10 from the retransmission control unit 90-1 of the short-distance retransmission unit 80-1 that is connected to the communication device 3-1 to the retransmission control unit 90-2 in the short-distance retransmission unit 80-2 that is connected to the communication device 3-2, via the reception multiplexer 91-1 and the transfer unit 81 (Step S403).

Next, the retransmission control unit 90-2 transfers the packet 10 to the communication device 3-2 via the transmission multiplexer 92-2 (Step S404).

Next, in the retransmission control unit 90-1, the ACK packet 41 in which a flag requesting the communication device 3-1 to perform retransmission control is “on” is created (Step S405).

In the retransmission control unit 90-1, the ACK packet 41 generated at Step S405 is transmitted to the communication device 3-1 and the operation is finished (Step S406). Meanwhile, the operations of S403 to S404 and S405 to S406 may be performed simultaneously.

When determining at Step S402 that the transmission destination of the packet 10 is the long-distance network 2, the repeating device 4 performs the operation of Step S407. The retransmission control unit 90-1 of the short-distance retransmission unit 80-1 generates the ACK packet 41 in which a flag showing that the repeating device 4 performs retransmission control is “on” (Step S407).

Next, the retransmission control unit 90-1 transmits the generated ACK packet 41 to the communication device 3-1 via the transmission multiplexer 92-1 (Step S408).

Next, the retransmission control unit 90-1 performs retransmission processing of the packet 10, and generates the packet 10 in which retransmission information such as the retransmission count 51 is initialized (Step S409).

After that, the retransmission control unit 90-1 outputs the packet 10 generated at Step S409 to the long-distance network 2 via the transfer unit 81, and finishes operation (Step S410). Meanwhile, the operations of S407 to S408 and S409 to S410 may be performed in parallel.

The main retransmission operation of the repeating device 4 is performed by the retransmission control unit 90 of the short-distance retransmission unit 80. This operation is similar to the operation flow of the retransmission control unit 21 of the communication device 3 shown in FIG. 11, and the detailed description will be omitted.

Here, when it is determined at Step S402 that the transmission destination of the packet 10 is the long-distance network 2, an operation for determining whether a repeating device which is located in the destination connected via the long-distance network 2 supports retransmission control may be performed. In the example of FIG. 14, it is determined whether the repeating device 4-2 in the short-distance network 1-2 connected via the long-distance network 2 supports retransmission control or not. Meanwhile, as timing of that operation, it can be performed during Steps S407 to S409, or in parallel.

When determining at Step S401 that the transmission source of the packet 10 is the long-distance network 2, Step S411 is performed. When it is determined that the transmission source of the packet 10 is the long-distance network 2, the retransmission control unit 90-1 determines where the transmission destination of the packet 10 is (not shown in FIG. 14). In the example of FIG. 14, it is supposed that a transmission destination of the packet 10 is the communication device 3-2. Accordingly, the repeating device 4 transfers the packet 10 received by the transfer unit 81 to the retransmission control unit 90-2 in the short-distance retransmission unit 80-2 connected to the communication device 3-2 (Step S411).

Next, the retransmission control unit 90-2 generates the ACK packet 41 for the received packet 10 (Step S412).

The retransmission control unit 90-2 transfers the ACK packet 41 generated in Step S412 to the long-distance network 2 via the transfer unit 81 (Step S413).

Next, the retransmission control unit 90-2 performs retransmission processing of the packet 10, and generates the packet 10 in which retransmission information such as the retransmission count 51 is initialized (Step S414).

The retransmission control unit 90-2 transfers the packet 10 generated in Step S414 to the communication device 3-2 via the transmission multiplexer 92-2, and finishes operation (Step S415). Meanwhile, the operations of S412 to S413 and S414 to S415 may be performed simultaneously.

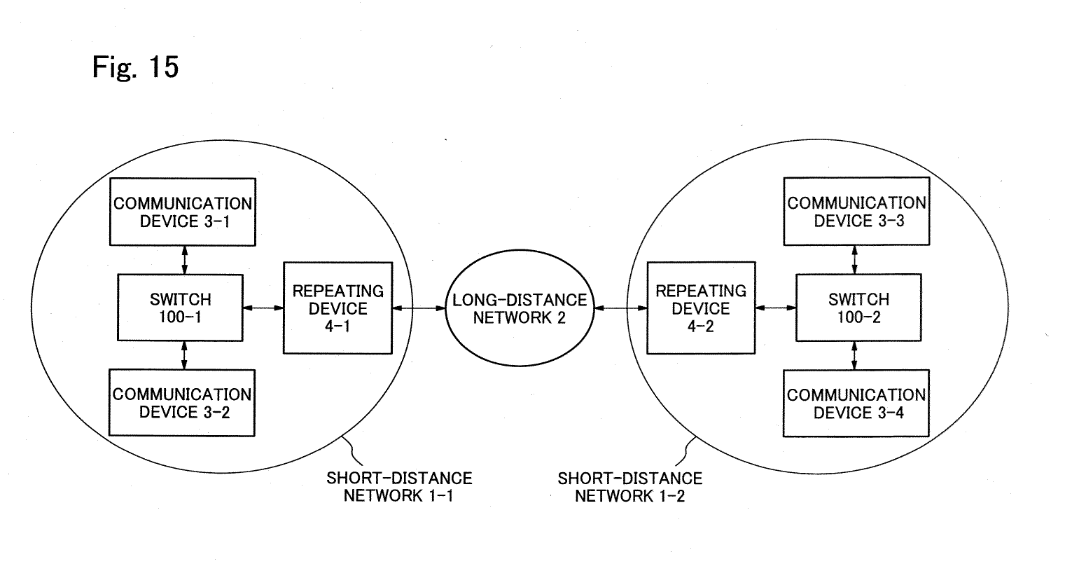

FIG. 15 is a block diagram showing a modification of a communication system according to this exemplary embodiment. In this modification, the repeating device 4 is connected to the communication device 3 via a switch 100. More in detail, communication within the short-distance network 1 is performed without going through the repeating device 4. Therefore, the packet 10 to be transmitted to the repeating device 4 from the communication device 3 is transmitted to the long-distance network 2 without exception.

(Advantage)

According to this exemplary embodiment, the repeating device 4 determines whether the destination of a received packet is within a communication system or outside the communication system first. As a result of the determination, when it is outside the communication system, a repeating device performs retransmission control, and when it is within the communication system, it makes a communication device which is the packet transmission source perform retransmission control. That is, retransmission control with a short distance communication path is performed by the communication device of the transmitting source, and retransmission control with a long distance communication path is performed by a repeating device itself.

By the above, a communication device besides the repeating device does not need to perform the packet retransmission control in long-distance communications. Accordingly, increase of a memory which a communication device is required in retransmission control can be avoided.

In addition, also in long-distance communications, a method of retransmission control disclosed in non-patent document 1 can be carried out. In this case, it has the effect that the communication efficiency of an entire system improves.

<Modification 1>

Next, modification 1 of the second exemplary embodiment will be described.

First, FIG. 15 is a diagram in which a switch 100-1 is provided inside the short-distance network 1-1, and a switch 100-2 is provided inside the short-distance network 1-2 of the second exemplary embodiment shown in FIG. 3, respectively. As is the case in FIG. 3, although there exist a plurality of pieces of communication device 3 and a plurality of pieces of repeating device 4 in FIG. 15, the functions of each of them are similar. Because the functions of switch 100-1 and switch 100-2 are also similar, as far as they do not need to be distinguished in particular, hereinafter each of them is called a switch 100.

By installing the switch 100, the repeating device 4 in modification 1 does not need to process a packet which is communicated inside the short-distance network 1 such as communication between the communication device 3-1 and the communication device 3-2, for example. Therefore, an operation of packet sending and receiving in the repeating device 4 becomes concise, and the transfer capability of the repeating device 4 can be improved.

Also, it is possible to apply retransmission control in the switch 100. When retransmission control is applied in the switch 100, retransmission control is terminated in all routes which connect each device. Accordingly, it is possible to further reduce a probability that disposal of a packet is caused. Therefore, it becomes possible to improve the reliability of a network by providing the switch 100 that can perform retransmission control.

When retransmission control is not applied in the switch 100, devices which perform retransmission control are limited to the communication device 3 and the repeating device 4. For this reason, when there exist many pieces of switch 100 in the short-distance network 1, because it can be expected to obtain the effect of the exemplary embodiment 2 by minimum mounting of the retransmission control function, highly convenient operation becomes possible.

<Modification 2>

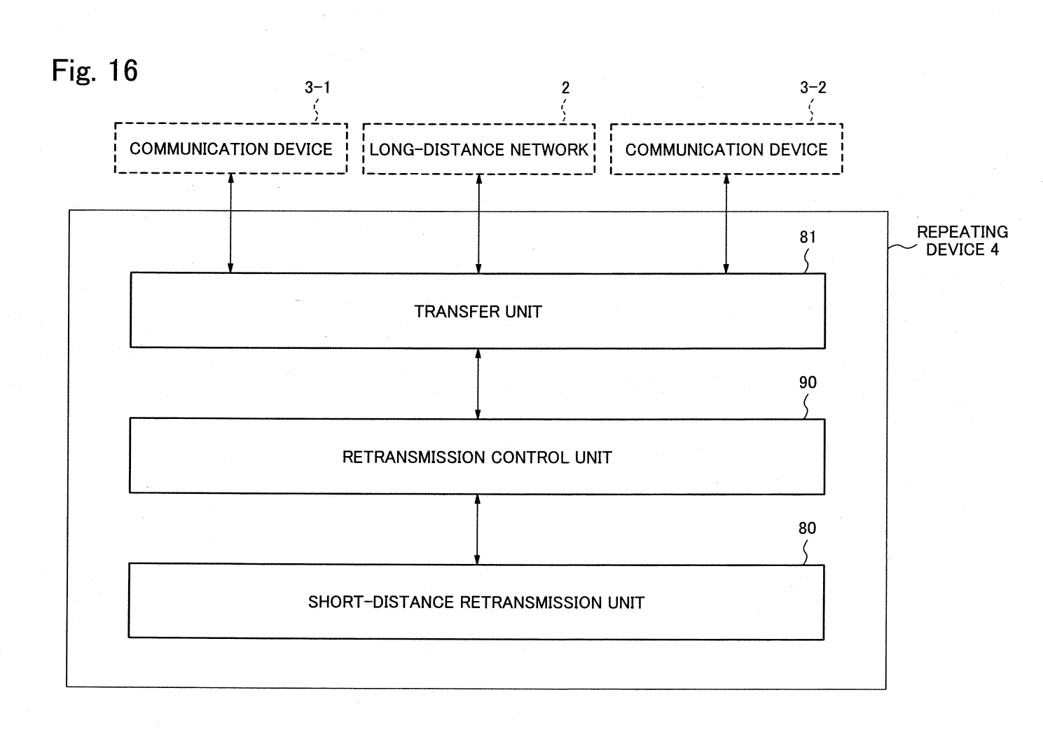

Next, modification 2 of the second exemplary embodiment will be described. FIG. 16 is a diagram showing a modification of the repeating device 4 in the second exemplary embodiment.

As shown in FIG. 9, in the repeating device 4 of the second exemplary embodiment, there are installed pieces of the short-distance retransmission unit 80 as many as the number of pieces of the communication device 3. On the other hand, in modification 2, the short-distance retransmission unit 80 in the repeating device 4 is not plural, and is single. All pieces of packet 10 transmitted from the communication device 3 in the short-distance network 1 are inputted to this short-distance retransmission unit 80. The short-distance retransmission unit 80 determines the destinations of received pieces of packet 10, and divides the packets to the communication device 3-1 and 3-2 via the transfer unit 81. Similarly, the retransmission control unit 90 is separated from the short-distance retransmission unit 80, and operates as a single unit like the short-distance retransmission unit 80. Meanwhile, because the operation of the retransmission control unit 90 is the same as that of the second exemplary embodiment, the detailed description will be omitted.

The repeating device 4 in modification 2 has a simpler structure compared with FIG. 9. Accordingly, management and load sharing of each unit can become easy, and, as a result, the processing capability of the repeating device 4 can be improved.

<Modification 3>

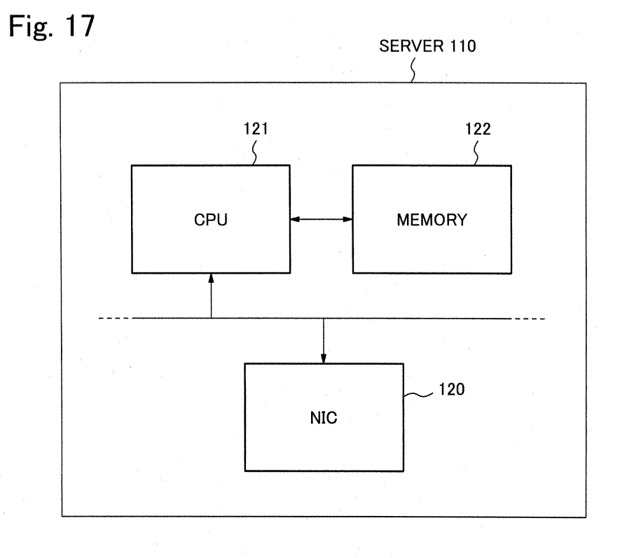

Modification 3 of the second exemplary embodiment will be described. FIG. 17 is a diagram showing a hardware exemplary configuration of the communication device 3 and the repeating device 4 of the exemplary embodiment 2.

The functions of the communication device 3 and the repeating device 4 are mounted on one server 110. The server 110 includes a NIC (Network Interface Card) 120, a CPU (Central Processing Unit) 121 and a memory 122.

The functions of the communication device 3 and the repeating device 4 can be realized by such hardware, or it can be realized by cooperation of a computer (the server 110) and a program executed on the computer.

More in detail, the NIC 120 which sends and receives the packet 10 takes on the packet transmitting and receiving function of the transmission unit 30 and the reception unit 31 of the communication device 3, and the short-distance retransmission unit 80 and the transfer unit 81 of the repeating device 4. The CPU 121 that performs packet processing takes on the function about the packet processing in each unit in the above-mentioned exemplary embodiments. The retransmission buffer 61 included in each above-mentioned unit is stored in the memory 122.

A program realized on the above server 110 is provided in a manner being recorded in a recording medium such as a magnetic disk and a semiconductor memory and the like, and it is read by a computer at the time of starting it and the like. By thus controlling operations of a computer, and making the computer function as the communication device 3 and the repeating device 4 in each of the above-mentioned exemplary embodiments, the processing mentioned above is performed.

<Problem of the Preceding Technical Documents Indicated in Background Art>

In long-distance communication like communication between data centers, when passing through a network in which its communication standard is different from that of the data centers, retransmission control and congestion control depends on the system of the network passed through. In most cases, its transfer performance declines compared with communication in a data center. Because information managed in a data center is required high reliability, it is desired that higher-speed transmission is performed.

As an idea for realizing higher-speed transmission, there is cited an idea that, in a network in which a communication system of the MAC layer is standardized like non-patent document 3, the communication efficiency is improved and higher-speed transmission is performed by performing retransmission control in the MAC layer according to non-patent document 1. However, this communication system has the following problem.

When retransmission control like non-patent document 1 is performed, because a buffer area needed for devices which perform retransmission control is proportional to the length of a communication interval, an enormous buffer area is required by retransmission in long-distance communication.

In retransmission control, a sender of retransmission finishes retransmission by an ACK from the retransmission destination. When an ACK is not received even after a time-out set in advance has passed, the sender of the retransmission re-executes retransmission according to an upper limit value of the number of retransmissions.

Here, in order to prepare for retransmission, the sender needs to hold packet information. A time during which packet information is held is a time from the transmission time of a retransmission packet to expiration of a time-out at the largest. Also, as a time-out, it is needed to set a numerical value at least equal to or larger than a communication time in which communication is performed in the state that discarding of a packet does not occur. When a time-out is set to a numerical value smaller than this numerical value, wasteful retransmission occurs even in normal communication.

In long-distance communication, when the above-mentioned retransmission method is applied, a numerical value of a time-out will be a very large numerical value compared with a short-distance case, and the amount of information that a sender should hold increases proportionally. It is difficult to cope with such amount by a size of a memory installed in a general-purpose communication apparatus.

By the similar reason, also in a retransmission method disclosed in patent document 1 and patent document 2, in a long-distance communication such as one passing through between data centers, a buffer capacity required for a communication terminal cannot be reserved.

According to the present invention, in long-distance communication, it has the effect that increase of a memory size needed for retransmission control in a communication device can be avoided.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

A part or all of the above-mentioned exemplary embodiments can be described as, but not limited to, the following supplementary notes.

(Supplementary Note 1)

A repeating device, connected with a communication device sending and receiving a packet via a network, for relaying said packet,

said repeating device comprising:

a destination determination unit for determining whether a destination of a received retransmission packet is within a communication system including said repeating device or outside said communication system; and

a retransmission control unit for performing retransmission control of said received retransmission packet, when a result of said determination shows a destination of said received retransmission packet is outside said communication system, and requesting retransmission control of said received retransmission packet to a transmission source of said received retransmission packet, when said result of said determination shows said destination of said received retransmission packet is within said communication system.

(Supplementary Note 2)

The repeating device according to supplementary note 1, said repeating device further comprising:

a transmission source determination unit for determining whether a transmission source of said received retransmission packet is within said communication system or outside said communication system, wherein

said retransmission control unit further initializes information required for retransmission of said retransmission packet and performs retransmission control of said retransmission packet, when said result of said determination shows a transmission source of said retransmission packet being outside said communication system.

(Supplementary Note 3)

The repeating device according to supplementary note 1 or 2, wherein said retransmission packet includes a packet identifier for indicating identification information of said retransmission packet, and retransmission count information for indicating a number of times of retransmission of said retransmission packet.

(Supplementary Note 4)

The repeating device according to supplementary note 3, said repeating device further comprising:

a retransmission packet determination unit for determining whether a received packet is a retransmission packet or not based on said retransmission count information included in said received packet.

(Supplementary Note 5)

The repeating device according to supplementary note 4, wherein said retransmission control unit transfers said received packet to a destination of said received packet, when said received packet is not a retransmission packet.

(Supplementary Note 6)

The repeating device according to any one of supplementary notes 1 to 5, wherein said destination determination unit, based on identification information of a communication device of a destination of said received retransmission packet, said identification information being included in a packet identifier of said received retransmission packet, determines whether a destination of said received retransmission packet exists within said communication system or outside said communication system.

(Supplementary note 7)

The repeating device according to any one of supplementary notes 3 to 6, wherein said transmission source determination unit, based on an identification information of a communication device of a sender of said received retransmission packet, said identification information being included in a packet identifier of said received retransmission packet, determines whether a transmission source of said received retransmission packet is within said communication system or outside said communication system.

(Supplementary Note 8)

A communication system including a communication device sending and receiving a packet via a network and a repeating device relaying said packet,

said repeating device comprising:

a destination determination unit for determining whether a destination of a received retransmission packet is within said communication system or outside said communication system; and

a retransmission control unit for performing retransmission control of said received retransmission packet, when a result of said determination shows a destination of said received retransmission packet is outside said communication system, and requesting retransmission control of said received retransmission packet to a transmission source of said received retransmission packet, when said result of said determination shows said destination of said received retransmission packet is within said communication system.

(Supplementary Note 9)

The communication system according to supplementary note 8, said repeating device further comprising:

a transmission source determination unit for determining whether a transmission source of said received retransmission packet is within said communication system or outside said communication system, wherein

said retransmission control unit further initializes information required for retransmission of said retransmission packet and performs retransmission control of said retransmission packet, when said result of said determination shows a transmission source of said retransmission packet being outside said communication system.

(Supplementary Note 10)

The communication system according to supplementary note 8 or 9, wherein said retransmission packet includes a packet identifier for indicating identification information of said retransmission packet, and retransmission count information for indicating a number of times of retransmission of said retransmission packet.

(Supplementary Note 11)

The communication system according to supplementary note 10, said repeating device further comprising:

a retransmission packet determination unit for determining whether a received packet is a retransmission packet or not based on said retransmission count information included in said received packet.

(Supplementary Note 12)

The communication system according to supplementary note 11, wherein said retransmission control unit transfers said received packet to a destination of said received packet when said received packet is not a retransmission packet.

(Supplementary Note 13)

The communication system according to any one of supplementary notes 10 to 12, wherein said destination determination unit, based on identification information of a communication device of a destination of said received retransmission packet, said identification information being included in a packet identifier of said received retransmission packet, determines whether a destination of said received retransmission packet exists within said communication system or outside said communication system.

(Supplementary Note 14)

The communication system according to any one of supplementary notes 10 to 13, wherein said transmission source determination unit, based on an identification information of a communication device of a sender of said received retransmission packet, said identification information being included in a packet identifier of said received retransmission packet, determines whether a transmission source of said received retransmission packet is within said communication system or outside said communication system.

(Supplementary Note 15)

A communication method, comprising:

a destination determination step of determining whether a destination of a received retransmission packet is within a communication system including a repeating device for relaying said packet, said repeating device being connected with a communication device sending and receiving a packet via a network, or outside said communication system; and

a retransmission control step of performing retransmission control of said received retransmission packet, when a result of said determination shows a destination of said received retransmission packet is outside said communication system, and requesting retransmission control of said received retransmission packet to a transmission source of said received retransmission packet, when said result of said determination shows said destination of said received retransmission packet is within said communication system.

(Supplementary Note 16)

The communication method according to supplementary note 15, said communication method further comprising:

a transmission source determination step of determining whether a transmission source of said received retransmission packet is within said communication system or outside said communication system, wherein

said retransmission control step further initializes information required for retransmission of said retransmission packet and performs retransmission control of said retransmission packet, when said result of said determination shows a transmission source of said retransmission packet is outside said communication system.

(Supplementary Note 17)

The communication method according to supplementary note 15 or 16, wherein said retransmission packet includes a packet identifier for indicating identification information of said retransmission packet, and retransmission count information for indicating a number of times of retransmission of said retransmission packet.

(Supplementary Note 18)

The communication method according to supplementary note 17, said communication method further comprising:

a retransmission packet determination step of determining whether a received packet is a retransmission packet or not based on said retransmission count information included in said received packet.

(Supplementary Note 19)

The communication method according to supplementary note 18, wherein said retransmission control step transfers said received packet to a destination of said received packet when said received packet is not a retransmission packet.

(Supplementary Note 20)

The communication method according to any one of supplementary notes 17 to 19, wherein said destination determination step, based on identification information of a communication device of a destination of said received retransmission packet, said identification information being included in a packet identifier of said received retransmission packet, determines whether a destination of said received retransmission packet exists within said communication system or outside said communication system.

(Supplementary Note 21)

The communication method according to any one of supplementary notes 17 to 20, wherein said transmission source determination step, based on an identification information of a communication device of a sender of said received retransmission packet, said identification information being included in a packet identifier of said received retransmission packet, determines whether a transmission source of said received retransmission packet is within said communication system or outside said communication system.

(Supplementary Note 22)

A recording medium for recording a program to cause a computer to carry out: destination determination processing for determining whether a destination of a received retransmission packet is within a communication system including a repeating device for relaying said packet, said repeating device being connected with a communication device sending and receiving a packet via a network, or outside said communication system; and

retransmission control processing to perform retransmission control of said received retransmission packet, when a result of said determination shows a destination of said received retransmission packet is outside said communication system, and to request retransmission control of said received retransmission packet to a transmission source of said received retransmission packet, when said result of said determination shows said destination of said received retransmission packet is within said communication system.

(Supplementary Note 23)

The recording medium for recording a program according to supplementary note 22, said program further comprising:

transmission source determination processing to determine whether a transmission source of said received retransmission packet is within said communication system or outside said communication system, wherein

said retransmission control processing further initializes information required for retransmission of said retransmission packet and performs retransmission control of said retransmission packet, when said result of said determination shows a transmission source of said retransmission packet is outside said communication system.

(Supplementary Note 24)

The recording medium for recording a program according to supplementary note 22 or 23, wherein said retransmission packet includes a packet identifier for indicating identification information of said retransmission packet, and retransmission count information for indicating a number of times of retransmission of said retransmission packet.

(Supplementary Note 25)

The recording medium for recording a program according to supplementary note 24, said program further comprising:

retransmission packet determination processing to determine whether a received packet is a retransmission packet or not based on said retransmission count information included in said received packet.

(Supplementary Note 26)

The recording medium for recording a program according to supplementary note 25, wherein said retransmission control processing transfers said received packet to a destination of said received packet when said received packet is not a retransmission packet.

(Supplementary Note 27)

The recording medium for recording a program according to any one of supplementary notes 24 to 26, wherein said destination determination processing, based on identification information of a communication device of a destination of said received retransmission packet, said identification information being included in a packet identifier of said received retransmission packet, determines whether a destination of said received retransmission packet exists within said communication system or outside said communication system.

(Supplementary Note 28)

The communication method according to any one of supplementary notes 24 to 227, wherein said transmission source determination processing, based on an identification information of a communication device of a sender of said received retransmission packet, said identification information being included in a packet identifier of said received retransmission packet, determines whether a transmission source of said received retransmission packet is within said communication system or outside said communication system.

1) A repeating device, connected with a communication device sending and receiving a packet via a network, for relaying said packet,
said repeating device comprising:
a destination determination unit for determining whether a destination of a received retransmission packet is within a communication system including said repeating device or outside said communication system; and
a retransmission control unit for performing retransmission control of said received retransmission packet, when a result of said determination shows a destination of said received retransmission packet is outside said communication system, and requesting retransmission control of said received retransmission packet to a transmission source of said received retransmission packet, when said result of said determination shows said destination of said received retransmission packet is within said communication system.

2) The repeating device according to claim 1, said repeating device further comprising:
a transmission source determination unit for determining whether a transmission source of said received retransmission packet is within said communication system or outside said communication system, wherein
said retransmission control unit further initializes information required for retransmission of said retransmission packet and performs retransmission control of said retransmission packet, when said result of said determination shows a transmission source of said retransmission packet being outside said communication system.

3) The repeating device according to claim 1, wherein said retransmission packet includes a packet identifier for indicating identification information of said retransmission packet, and retransmission count information for indicating a number of times of retransmission of said retransmission packet.

4) The repeating device according to claim 3, said repeating device further comprising:
a retransmission packet determination unit for determining whether a received packet is a retransmission packet or not based on said retransmission count information included in said received packet.

5) The repeating device according to claim 4, wherein said retransmission control unit transfers said received packet to a destination of said received packet, when said received packet is not a retransmission packet.

6) The repeating device according to claim 1, wherein said destination determination unit, based on identification information of a communication device of a destination of said received retransmission packet, said identification information being included in a packet identifier of said received retransmission packet, determines whether a destination of said received retransmission packet exists within said communication system or outside said communication system.

7) The repeating device according to claim 3, wherein said transmission source determination unit, based on an identification information of a communication device of a sender of said received retransmission packet, said identification information being included in a packet identifier of said received retransmission packet, determines whether a transmission source of said received retransmission packet is within said communication system or outside said communication system.

8) A communication system including a communication device sending and receiving a packet via a network and a repeating device relaying said packet,
said repeating device comprising:
a destination determination unit for determining whether a destination of a received retransmission packet is within said communication system or outside said communication system; and
a retransmission control unit for performing retransmission control of said received retransmission packet, when a result of said determination shows a destination of said received retransmission packet is outside said communication system, and requesting retransmission control of said received retransmission packet to a transmission source of said received retransmission packet, when said result of said determination shows said destination of said received retransmission packet is within said communication system.

9) The communication system according to claim 8, said repeating device further comprising:
a transmission source determination unit for determining whether a transmission source of said received retransmission packet is within said communication system or outside said communication system, wherein
said retransmission control unit further initializes information required for retransmission of said retransmission packet and performs retransmission control of said retransmission packet, when said result of said determination shows a transmission source of said retransmission packet being outside said communication system.

10) The communication system according to claim 8, wherein said retransmission packet includes a packet identifier for indicating identification information of said retransmission packet, and retransmission count information for indicating a number of times of retransmission of said retransmission packet.

11) The communication system according to claim 10, said repeating device further comprising:
a retransmission packet determination unit for determining whether a received packet is a retransmission packet or not based on said retransmission count information included in said received packet.

12) The communication system according to claim 11, wherein said retransmission control unit transfers said received packet to a destination of said received packet when said received packet is not a retransmission packet.

13) The communication system according to claim 10, wherein said destination determination unit, based on identification information of a communication device of a destination of said received retransmission packet, said identification information being included in a packet identifier of said received retransmission packet, determines whether a destination of said received retransmission packet exists within said communication system or outside said communication system.

14) The communication system according to claim 10, wherein said transmission source determination unit, based on an identification information of a communication device of a sender of said received retransmission packet, said identification information being included in a packet identifier of said received retransmission packet, determines whether a transmission source of said received retransmission packet is within said communication system or outside said communication system.

15) A communication method, comprising the steps of:
determining whether a destination of a received retransmission packet is within a communication system including a repeating device for relaying said packet, said repeating device being connected with a communication device sending and receiving a packet via a network, or outside said communication system; and
performing retransmission control of said received retransmission packet, when a result of said determination shows a destination of said received retransmission packet is outside said communication system, and requesting retransmission control of said received retransmission packet to a transmission source of said received retransmission packet, when said result of said determination shows said destination of said received retransmission packet is within said communication system.

16) The communication method according to claim 15, said communication method further comprising:
determining whether a transmission source of said received retransmission packet is within said communication system or outside said communication system, wherein
said performing retransmission control further initializes information required for retransmission of said retransmission packet and performs retransmission control of said retransmission packet, when said result of said determination shows a transmission source of said retransmission packet is outside said communication system.

17) The communication method according to claim 15, wherein said retransmission packet includes a packet identifier for indicating identification information of said retransmission packet, and retransmission count information for indicating a number of times of retransmission of said retransmission packet.

18) The communication method according to claim 17, said communication method further comprising:
determining whether a received packet is a retransmission packet or not based on said retransmission count information included in said received packet.

19) The communication method according to claim 18, wherein said performing retransmission control transfers said received packet to a destination of said received packet when said received packet is not a retransmission packet.

20) The communication method according to claim 17, wherein said destination determining, based on identification information of a communication device of a destination of said received retransmission packet, said identification information being included in a packet identifier of said received retransmission packet, determines whether a destination of said received retransmission packet exists within said communication system or outside said communication system.

21) The communication method according to claim 17, wherein said transmission source determining, based on an identification information of a communication device of a sender of said received retransmission packet, said identification information being included in a packet identifier of said received retransmission packet, determines whether a transmission source of said received retransmission packet is within said communication system or outside said communication system.

22) A recording medium for recording a program to cause a computer to carry out: destination determination processing for determining whether a destination of a received retransmission packet is within a communication system including a repeating device for relaying said packet, said repeating device being connected with a communication device sending and receiving a packet via a network, or outside said communication system; and
retransmission control processing to perform retransmission control of said received retransmission packet, when a result of said determination shows a destination of said received retransmission packet is outside said communication system, and to request retransmission control of said received retransmission packet to a transmission source of said received retransmission packet, when said result of said determination shows said destination of said received retransmission packet is within said communication system.

23) The recording medium for recording a program according to claim 22, said program further comprising:
transmission source determination processing to determine whether a transmission source of said received retransmission packet is within said communication system or outside said communication system, wherein
said retransmission control processing further initializes information required for retransmission of said retransmission packet and performs retransmission control of said retransmission packet, when said result of said determination shows a transmission source of said retransmission packet is outside said communication system.

24) The recording medium for recording a program according to claim 22, wherein said retransmission packet includes a packet identifier for indicating identification information of said retransmission packet, and retransmission count information for indicating a number of times of retransmission of said retransmission packet.

25) The recording medium for recording a program according to claim 24, said program further comprising:
retransmission packet determination processing to determine whether a received packet is a retransmission packet or not based on said retransmission count information included in said received packet.

26) The recording medium for recording a program according to claim 25, wherein said retransmission control processing transfers said received packet to a destination of said received packet when said received packet is not a retransmission packet.

27) The recording medium for recording a program according to claim 24, wherein said destination determination processing, based on identification information of a communication device of a destination of said received retransmission packet, said identification information being included in a packet identifier of said received retransmission packet, determines whether a destination of said received retransmission packet exists within said communication system or outside said communication system.

28) The communication method according to claim 24, wherein said transmission source determination processing, based on an identification information of a communication device of a sender of said received retransmission packet, said identification information being included in a packet identifier of said received retransmission packet, determines whether a transmission source of said received retransmission packet is within said communication system or outside said communication system.
